(19) United States
(12) Patent Application Publication
(10) Pub. No.: US 2024/0282912 A1
(43) Pub. Date: Aug. 22, 2024

(54) ELECTROCHEMICAL DEVICE

(71) Applicant: Panasonic Intellectual Property Management Co., Ltd., Osaka (JP)

(72) Inventors: NOBUHIRO SHIMAMURA, Osaka (JP); KENICHI NAGAMITSU, Kyoto (JP)

(21) Appl. No.: 18/548,892

(22) PCT Filed: Mar. 17, 2022
(86) PCT No.: PCT/JP2022/012117

§ 371 Date: Feb. 2, 2024

(30) Foreign Application Priority Data
Mar. 26, 2021 (JP) 2021-053950

(51) Int. Cl. H01M 4/133; H01M 4/02; H01M 4/587; H01M 4/62; H01M 10/0525

(52) U.S. Cl. CPC H01M 4/133; H01M 4/587; H01M 4/625; H01M 10/0525; H01M 2004/021; H01M 2004/027

(57) ABSTRACT

The present disclosure provides a high-output electrochemical device with a low internal resistance, the electrochemical device including a positive electrode, a negative electrode, and an electrolyte having lithium ion conductivity. The negative electrode includes a negative current collector and a negative electrode mixture layer supported on the negative current collector. The negative electrode mixture layer contains a conductive additive and a negative electrode active material reversibly doped with a lithium ion. A surface area A per unit mass of the negative electrode mixture layer and a mass B of the negative electrode mixture layer supported on a unit area of the negative current collector on one surface satisfy a relationship of 200≤AB≤1,400.

### TECHNICAL FIELD

The present invention relates to an electrochemical device.

### BACKGROUND

In recent years, electrochemical devices in which the electricity storage principles of a lithium ion secondary battery and an electric double layer capacitor are combined have attracted attention. Such electrochemical devices typically use a polarizable electrode for a positive electrode and a non-polarizable electrode for a negative electrode. As a result, the electrochemical devices are expected to have both the high energy density of a lithium ion secondary battery and the high output characteristic of an electric double layer capacitor.

PTL 1 proposes a lithium ion capacitor including a positive electrode, a negative electrode, and an aprotic organic solvent electrolyte solution of a lithium salt as an electrolytic solution, wherein a positive electrode active material is a material capable of being doped and dedoped with lithium ions or anions, a negative electrode active material is a material capable of being doped and dedoped with lithium ions, the negative electrode or the positive electrode is doped with lithium ions such that the positive electrode has a potential of less than or equal to 2 V (vs. Li/Li+) after the positive electrode and the negative electrode are short-circuited, the positive electrode has a positive electrode layer formed with a same thickness on both sides of a current collector, the positive electrode layer has a total thickness of 18 μm to 108 μm, and the positive electrode active material has a total basis weight of 1.5 mg/cm² to 4.0 mg/cm².

PTL 2 proposes a lithium ion capacitor including a positive electrode, a negative electrode, and an aprotic organic solvent electrolyte solution of a lithium salt as an electrolytic solution, wherein a positive electrode active material is a material capable of reversibly supporting lithium ions or anions, a negative electrode active material is a material capable of reversibly supporting lithium ions, the negative electrode or the positive electrode is doped with lithium ions before charging such that the positive electrode has a potential of less than or equal to 2.0 V after the positive electrode and the negative electrode are short-circuited, and the negative electrode active material is a heat treated product of a carbon material precursor in the presence of a transition metal-containing material.

### ClTATION LIST

### Patent Literature

PTL 1: Japanese Patent No. 4971729
PTL 2: Unexamined Japanese Patent Publication No. 2006-310412

### SUMMARY

However, further improvement of the electrochemical device as described above is needed to achieve a high output at higher levels.

In an electrochemical device, the internal resistance (DCR) tends to increase particularly at a low temperature. Further, when float charging in which a constant voltage is applied to an electrochemical device by using an external DC power supply is performed at a high temperature, the internal resistance tends to increase. To obtain high output characteristics, a reduction in initial internal resistance and a reduction in internal resistance after a float test are required.

One aspect of the present invention relates to an electrochemical device including a positive electrode, a negative electrode, and an electrolyte having lithium ion conductivity. The negative electrode includes a negative current collector and a negative electrode mixture layer supported on the negative current collector. The negative electrode mixture layer contains a conductive additive and a negative electrode active material reversibly doped with a lithium ion. A surface area A (m²/g) per unit mass of the negative electrode mixture layer and a mass B (g/m²) of the negative electrode mixture layer supported on a unit area of the negative current collector on one surface satisfy a relationship of 200≤AB≤1,400.

According to the present invention, a high-output electrochemical device can be provided.

### BRIEF DESCRIPTION OF THE DRAWINGS

FIG. 1 is a longitudinal sectional view illustrating an electrochemical device according to an exemplary embodiment of the present invention.

### DESCRIPTION OF EMBODIMENT

An electrochemical device according to an exemplary embodiment of the present invention includes a positive electrode, a negative electrode, and an electrolyte having lithium ion conductivity. Typical positive electrode and negative electrode constitute an electrode body together with a separator interposed therebetween. The electrode body is configured as, for example, a columnar wound body in which a band-shaped positive electrode and a band-shaped negative electrode are wound with a separator interposed therebetween. The electrode body may also be formed as a stacked body in which a plate-shaped positive electrode and a plate-shaped negative electrode are stacked with a separator interposed therebetween.

The positive electrode includes, for example, a positive current collector and a positive electrode mixture layer supported on the positive current collector. The positive electrode mixture layer contains a positive electrode active material reversibly doped with an anion. When an anion is adsorbed to the positive electrode active material, an electric double layer forms to develop a capacitance. The positive electrode may be a polarizable electrode or may be an electrode that has the properties of a polarizable electrode and in which the Faraday reaction also contributes to the capacitance.

The positive electrode active material may be a carbon material or a conductive polymer. The doping of the anion into the positive electrode active material is a concept that includes at least an adsorption phenomenon of the anion to the positive electrode active material and may include occlusion of the anion by the positive electrode active material and chemical interaction between the positive electrode active material and the anion.

The negative electrode includes a negative current collector and a negative electrode mixture layer supported on the negative current collector. The negative electrode mixture layer contains a conductive additive and a negative electrode active material reversibly doped with lithium ions. In the negative electrode, the Faraday reaction in which lithium ions are reversibly occluded and released proceeds to develop a capacitance. The doping of the negative electrode active material with lithium ions is a concept that includes at least an occlusion phenomenon of lithium ions into the negative electrode active material and may include adsorption of lithium ions to the negative electrode active material and chemical interaction between the negative electrode active material and lithium ions.

Hereinafter, the positive electrode and the negative electrode may be collectively referred to as electrodes. The positive current collector and the negative current collector may be collectively referred to as current collectors (or electrode current collectors). The positive electrode mixture layer and the negative electrode mixture layer may be collectively referred to as mixture layers (or electrode mixture layers). The positive electrode active material and the negative electrode active material may be collectively referred to as active materials (or electrode active materials).

Surface area A per unit mass of the negative electrode mixture layer and mass B of the negative electrode mixture layer supported on a unit area of the negative current collector on one surface satisfy the relationship of 200≤AB≤1,400. This configuration can reduce the initial internal resistance of the electrochemical device. In addition, deterioration of the negative electrode can be inhibited, and the internal resistance can be maintained low even after many charge and discharge cycles are repeated. As a result, high output characteristics can be realized.

The deterioration of the negative electrode is typically evaluated by an increase rate of the low-temperature DCR of the electrochemical device when float charging is performed at a high temperature by applying a constant voltage to the electrochemical device using an external DC power supply. The increase rate of the low-temperature DCR is a ratio of a difference (ΔDCR) between the initial low-temperature DCR and the low-temperature DCR after float charging to the initial low-temperature DCR of the electrochemical device. It can be said that the smaller the increase rate of the low-temperature DCR, the less the negative electrode deteriorates.

Hereinafter, surface area A per unit mass of the negative electrode mixture layer may be referred to as specific surface area A of the negative electrode mixture layer. Specific surface area A of the negative electrode mixture layer roughly reflects the specific surface area of the negative electrode active material. However, specific surface area A depends not only on the specific surface area of the negative electrode active material but also on the specific surface area and content of materials other than the negative electrode active material, such as a conductive additive and a binding agent, which may be contained in the negative electrode mixture layer, and how these materials are distributed in the mixture layer. Hereinafter, mass B of the negative electrode mixture layer supported on the unit area of the negative current collector on one surface may be referred to as basis weight B of the negative electrode mixture layer.

Product AB of specific surface area A and basis weight B of the negative electrode mixture layer has dimensionless quantity, and is an index indicating how many times the surface area of the negative electrode mixture layer is as large as the supporting area of the negative electrode mixture layer for the negative current collector.

When product AB is small (that is, the surface area is small with respect to the supporting area of the negative electrode mixture layer), the initial internal resistance increases, but deterioration of the negative electrode is inhibited. For example, an increase in internal resistance after the float test can be prevented. When product AB is large (that is, the surface area is large with respect to the supporting area of the negative electrode mixture layer), the initial internal resistance decreases, but deterioration of the negative electrode is likely to proceed. For example, the internal resistance after the float test is likely to increase, the difference between the initial internal resistance and the internal resistance after float charging increases, and as a result, the internal resistance after float charging increases. When product AB is less than 200, an increase in initial internal resistance is remarkable. When product AB exceeds 1,400, deterioration of the negative electrode rapidly proceeds, and the internal resistance after float charging excessively increases. In contrast, when product AB is in the range of 200 to 1,400, inclusive, both low initial internal resistance and low internal resistance after float charging can be achieved, and output characteristics can be maintained high.

Product AB of specific surface area A and basis weight B of the negative electrode mixture layer desirably satisfies 340≤AB≤1,000. In this case, the initial internal resistance and the internal resistance after float charging are significantly reduced, and the output characteristics of the electrochemical device can be further enhanced.

Specific surface area A of the negative electrode mixture layer may be, for example, 10 m²/g or more and 70 m²/g or less with product AB satisfying the above-described range. The initial internal resistance (DCR) tends to increase at a low temperature as the specific surface area B increases, but when the specific surface area of the negative electrode mixture layer is more than or equal to 10 m²/g, further, more than or equal to 17 m²/g, an increase in low-temperature DCR is remarkably inhibited. When specific surface area A of the negative electrode mixture layer is less than or equal to 70 m²/g, further, less than or equal to 50 m²/g, deterioration of the negative electrode is inhibited, and the durability of the electrochemical device is likely to improve.

Specific surface area A of the negative electrode mixture layer is a BET specific surface area determined using a measurement apparatus in accordance with JIS Z 8830 (for example, TriStar II 3020 manufactured by Shimadzu Corporation). Specifically, the electrochemical device is disassembled, and the negative electrode is taken out. A half cell is assembled using the negative electrode as a working electrode and a Li metal foil as a counter electrode, and the negative electrode is dedoped with Li until the negative electrode potential reaches 1.5 V. Next, the negative electrode dedoped with Li is washed with dimethyl carbonate (DMC) and dried. Thereafter, the negative electrode mixture layer is peeled off from the negative current collector, and about 0.5 g of a sample of the negative electrode mixture layer is collected.

Next, the collected sample is heated at 150° C. for 12 hours under a reduced pressure of less than or equal to 95 kPa, and thereafter, nitrogen gas is adsorbed to the sample whose mass is known to obtain an adsorption isotherm at a relative pressure in the range from 0 to 1. Then, the surface area of the sample is calculated from the monolayer adsorption amount of the gas obtained from the adsorption isotherm. Here, the specific surface area is determined from the following BET formula by the single-point BET method (relative pressure 0.3).

$$P / V ( P 0 - P ) = ( 1 / VmC ) + \{ ( C - 1 ) / VmC \} ( P / P 0 ) \qquad ( 1 )$$

$$S = kVm \qquad ( 2 )$$

P0: saturated vapor pressure
P: adsorption equilibrium pressure
V: adsorption amount at adsorption equilibrium pressure P
Vm: monolayer adsorption amount
C: parameter related to adsorption heat and the like
S: specific surface area
k: occupancy area of nitrogen single molecule of 0.162 nm²

Next, basis weight B of the negative electrode mixture layer is represented by the following formula. Here, the supporting area of the negative electrode mixture layer is the area of the negative electrode mixture layer in a projection view when the negative electrode is positively projected from the main surface side of the negative electrode.

$$Basis weight B = ( mass of negative electrode - mass of negative current collector ) \div ( supporting area of negative electrode mixture layer )$$

As a sample of the negative electrode for obtaining basis weight B, a uniform portion is cut out in a thickness direction of the negative electrode and used. For example, an electrode portion partially having an exposed part of a current collector is not used as the sample. An electrode portion in which a part where the electrode mixture layers are provided on both surfaces and a part where the electrode mixture layer is provided on one surface of a current collector are mixed is not used as the sample.

Basis weight B of the negative electrode mixture layer may be, for example, from 1.9 mg/cm² to 3.4 mg/cm², inclusive, and may be from 2.2 mg/cm² to 3.0 mg/cm², inclusive, as long as the product AB satisfies the above-described range. When electrode mixture layers are provided on both surfaces of a current collector, as derived from the above definition, basis weight B is calculated by dividing the total mass of the negative electrode mixture layers on both surfaces of the current collector having a unit area size by the total mass on both surfaces of the supporting area.

Needless to say, when product AB is calculated, the unit of basis weight B is converted into g/m² based on 1 mg/cm²=10 g/m² with respect to specific surface area A (m²/g).

The negative electrode mixture layer preferably contains carbon black as the conductive additive. Carbon black may have a specific surface area of from 800 m²/g to 1,200 m²/g, inclusive. By using carbon black having a specific surface area in such a range, basis weight B can be easily controlled so that product AB satisfies the above-described range, and a high-output electrochemical device can be easily realized.

The negative electrode active material preferably contains non-graphitizable carbon. Non-graphitizable carbon is also called hard carbon. By using non-graphitizable carbon, high cycle characteristics can be obtained even under charge and discharge conditions where rapid charge and rapid discharge are repeated. In addition, the internal resistance (DCR) is small even at a low temperature, and a high-output electrochemical device can be realized.

A surface layer part of the negative electrode mixture layer may have a first layer containing lithium carbonate (lithium carbonate-containing layer). The first layer is mainly formed on the surface of the negative electrode active material. Forming the first layer containing lithium carbonate remarkably inhibits deterioration of the negative electrode.

The surface layer part of the negative electrode mixture layer may further include a second layer (solid electrolyte layer) including a solid electrolyte layer. The second layer may be formed to cover at least a part of the surface of the first layer. The second layer has a composition different from that of the first layer, and the second layer is distinguishable from the first layer. In an electrochemical device using lithium ions, a solid electrolyte interface coating film (that is, an SEI coating film) is formed on the negative electrode mixture layer during charging and discharging. The second layer may be formed as the SEI coating film. The SEI coating film serves an important function in charge-discharge reaction, but an excessively thick SEI coating film causes the negative electrode to greatly deteriorate. On the other hand, the first layer containing lithium carbonate has an action of promoting formation of a favorable SEI coating film and maintaining the SEI coating film in a favorable state when charging and discharging are repeated. That is, the first layer is interposed between the surface of the negative electrode active material and the second layer and serves as an underlayer of the second layer, whereby the second layer is formed as an SEI coating film in a favorable state. Thus, formation of the first layer on the surface layer part of the negative electrode mixture layer can remarkably inhibit deterioration of the negative electrode even when the specific surface area of the negative electrode mixture layer is increased to inhibit an increase in the low-temperature DCR.

The second layer may also contain lithium carbonate. When the second layer contains lithium carbonate, the content of lithium carbonate contained in the second layer is smaller than the content of lithium carbonate contained in the first layer. It is a necessary condition that the first layer containing a large amount of lithium carbonate is used as an underlayer for the second layer to be formed as an SEI coating film in a favorable state.

The first layer is formed on the surface layer part of the negative electrode mixture layer before the electrochemical device is assembled. In the electrochemical device assembled using the negative electrode, the second layer (SEI coating film) having a uniform and appropriate thickness is formed on the surface of the negative electrode active material by subsequent charging and discharging. The SEI coating film is formed, for example, by a reaction between an electrolyte and the negative electrode in the electrochemical device. Since the electrolyte can pass through not only the second layer but also the first layer, the entire surface layer part including the first layer and the second layer may be referred to as the SEI coating film, but in the present specification, the second layer is referred to as the SEI coating film and distinguished from the first layer for convenience.

The presence of a region containing lithium carbonate such as the first layer may be confirmed by, for example, analysis of the surface layer part by X-ray photoelectron spectroscopy (XPS). The analysis method is not limited to XPS.

The thickness of the first layer may be, for example, more than or equal to 1 nm, may be more than or equal to 5 nm when a longer-term action is expected, and may be more than or equal to 10 nm when a more reliable action is expected. When the thickness of the first layer exceeds 50 nm, the first layer itself may be a resistance component. Thus, the thickness of the first layer may be less than or equal to 50 nm or may be less than or equal to 30 nm.

The thickness of the second layer is, for example, more than or equal to 1 nm or may be more than or equal to 3 nm. It is sufficient that the thickness thereof is more than or equal to 5 nm. When the thickness of the second layer exceeds 20 nm, the second layer itself may be a resistance component. Thus, the thickness of the second layer may be less than or equal to 20 nm or may be less than or equal to 10 nm.

The ratio A/B between thickness A of the first layer and thickness B of the second layer is preferably less than or equal to 1 from the viewpoint of reducing the initial low-temperature DCR. At this time, the thickness of the second layer is preferably less than or equal to 20 nm and may be less than or equal to 10 nm. However, from the viewpoint of forming the second layer in a favorable state, A/B is desirably more than or equal to 0.1, and for example, the A/B ratio may be more than or equal to 0.2.

The thicknesses of the first layer and the second layer are measured by analyzing the surface layer part of the negative electrode mixture layer at a plurality of locations (at least five locations) of the negative electrode mixture layer. Then, the average of the thickness of the first layer or second layer obtained at the plurality of locations may be set as the thickness of the first layer or second layer. The negative electrode mixture layer used as the measurement sample may be peeled off from the negative current collector. In this case, the coating film formed on the surface of the negative electrode active material constituting the vicinity of the surface layer part of the negative electrode mixture layer may be analyzed. Specifically, the negative electrode active material covered with the coating film may be collected from a region of the negative electrode mixture layer disposed on the surface opposite to the surface joined to the negative current collector and used for analysis.

In the XPS analysis of the surface layer part of the negative electrode mixture layer, for example, the surface layer part or the coating film formed on the surface of the negative electrode active material is irradiated with an argon beam in a chamber of an X-ray photoelectron spectrometer, and changes in each spectrum attributed to C1s, O1s electrons, and the like with respect to the irradiation time are observed and recorded. At this time, from the viewpoint of avoiding analysis error, the spectrum of the outermost surface of the surface layer part may be ignored. The thickness of the region where the peak attributed to lithium carbonate is stably observed corresponds to the thickness of the first layer.

In the case of a negative electrode taken out from an electrochemical device after completion and predetermined aging or at least one charging and discharging, the surface layer part of the negative electrode mixture layer has an SEI coating film (that is, the second layer) containing a solid electrolyte. The thickness of the region where the peak attributed to the bond of a compound contained in the SEI coating film is stably observed corresponds to the thickness of the SEI coating film (that is, the thickness of the second layer).

As the compound contained in the SEI coating film, a compound containing an element that may be a label of the second layer is selected. As the element that may be a label of the second layer, for example, an element that is contained in the electrolyte and is substantially not contained in the first layer (for example, F) may be selected. As the compound containing an element that may be a label of the second layer, for example, LiF may be selected.

When the second layer contains LiF, a substantial F1s peak attributed to the LiF bond is observed when the second layer is measured by X-ray photoelectron spectroscopy. In this case, the thickness of the region where the peak attributed to the LiF bond is stably observed corresponds to the thickness of the second layer.

On the other hand, the first layer usually does not contain LiF, and a substantial peak of F1s attributed to the LiF bond is not observed even when the first layer is measured by X-ray photoelectron spectroscopy. Thus, the thickness of the region where the peak attributed to the LiF bond is not stably observed may be used as the thickness of the first layer.

In the SEI coating film, O1s peaks attributed to lithium carbonate may also be observed. However, since the SEI coating film generated in the electrochemical device has a composition different from that of the first layer formed in advance, the SEI coating film and the first layer can be distinguished from each other. For example, in the XPS analysis of the SEI coating film, an F1s peak attributed to the LiF bond is observed, but a substantial F1s peak attributed to the LiF bond is not observed in the first layer. In addition, the amount of lithium carbonate contained in the SEI coating film is very small. As the Li1s peak, a peak derived from a compound such as ROCO₂Li or ROLi may be detected, for example.

When the first layer is analyzed by XPS, a second peak of O1s attributed to the Li—O bond may be observed in addition to the first peak of O1s attributed to the C═O bond. The region of the coating film present in the vicinity of the surface of the negative electrode active material may contain a slight amount of LiOH or Li₂O.

Specifically, when the first layer constituting the surface layer part of the negative electrode mixture layer is analyzed in a depth direction, a first region, in which a first peak (O1s attributed to the C═O bond) and a second peak (O1s attributed to the Li—O bond) are observed and a first peak intensity is larger than a second peak intensity, and a second region, in which the first peak and the second peak are observed and the second peak intensity is larger than the first peak intensity, may be observed in the order of increasing the distance from the outermost surface of the surface layer part. A third region in which the first peak is observed and the second peak is not observed may further be present, the third region being located closer to the outermost surface of the surface layer part than the first region. The third region is easily observed when the thickness of the lithium carbonate-containing region is large. The magnitude of the peak intensity may be determined by the height of the peak from the baseline.

At the center in the thickness direction of the first layer, usually, the C1s peak attributed to the C—C bond is not substantially observed, or even when observed, the C1s peak is half or less of the peak intensity attributed to the C═O bond.

Next, a method for forming the first layer containing lithium carbonate on the surface layer part of the negative electrode mixture layer will be described. The step of forming the first layer may be performed by, for example, a gas phase method, a coating method, transfer, or the like.

Examples of the gas phase method include chemical vapor deposition, physical vapor deposition, and sputtering. For example, lithium carbonate may be attached to the surface of the negative electrode mixture layer with a vacuum vapor deposition apparatus. The pressure in a chamber of the apparatus during vapor deposition may be, for example, from 10⁻² Pa to 10⁻⁵ Pa, the temperature of a lithium carbonate evaporation source may be from 400° C. to 600° C., and the temperature of the negative electrode mixture layer may be from −20° C. to 80° C.

As the coating method, the first layer may be formed by coating a solution or dispersion containing lithium carbonate on a surface of the negative electrode using, for example, a microgravure coater and drying the solution or dispersion. The content of lithium carbonate in the solution or dispersion is, for example, from 0.3 mass % to 2 mass %, inclusive, and when a solution is used, the content of lithium carbonate may be a concentration equal to or lower than the solubility (for example, about from 0.9 mass % to 1.3 mass %, inclusive, in the case of an aqueous solution at normal temperature).

Further, the negative electrode may be obtained by performing a step of forming the second layer containing a solid electrolyte so as to cover at least a part of the first layer. The surface layer part of the obtained negative electrode mixture layer has the first layer and the second layer. The second layer is formed such that at least a part of the second layer covers at least a part (preferably the whole) of the surface of the negative electrode active material with the first layer interposed therebetween (that is, the first layer is used as an underlayer).

Since the step of forming the second layer is performed in a state where the negative electrode mixture layer and the electrolyte are in contact with each other, the step may also serve as at least part of a step of pre-doping the negative electrode mixture layer with lithium ions. As a source of the lithium ions to be pre-doped, for example, metal lithium may be used.

Metal lithium may be attached to the surface of the negative electrode mixture layer. The first layer containing lithium carbonate having a thickness of, for example, from 1 nm to 50 nm, inclusive, may also be formed by exposing the negative electrode having the negative electrode mixture layer to which metal lithium is attached to a carbon dioxide gas atmosphere.

The step of attaching metal lithium to the surface of the negative electrode mixture layer may be performed by, for example, a gas phase method, transfer, or the like. Examples of the gas phase method include chemical vapor deposition, physical vapor deposition, and sputtering. For example, metal lithium may be formed into a film on the surface of the negative electrode mixture layer by a vacuum vapor deposition apparatus. The pressure in a chamber of the apparatus during vapor deposition may be, for example, from 10⁻² Pa to 10⁻⁵ Pa, the temperature of a lithium evaporation source may be from 400° C. to 600° C., and the temperature of the negative electrode mixture layer may be from −20° C. to 80° C.

The carbon dioxide gas atmosphere is preferably a dry atmosphere that does not contain moisture and may have, for example, a dew point of less than or equal to −40° C. or less than or equal to −50° C. The carbon dioxide gas atmosphere may contain gases other than carbon dioxide, but the molar fraction of carbon dioxide is preferably more than or equal to 80%, more preferably more than or equal to 95%. It is desirable that the carbon dioxide gas atmosphere does not contain an oxidizing gas, and the molar fraction of oxygen may be less than or equal to 0.1%.

To form the first layer to be thicker, it is efficient that the partial pressure of carbon dioxide is made larger than, for example, 0.5 atm (5.05×10⁴ Pa), and may be more than or equal to 1 atm (1.01×10⁵ Pa).

The temperature of the negative electrode exposed to the carbon dioxide gas atmosphere may be, for example, in the range from 15° C. to 120° C., inclusive. The higher the temperature, the thicker the first layer.

The thickness of the first layer may be easily controlled by changing the time for exposing the negative electrode to the carbon dioxide gas atmosphere. The exposure time may be, for example, more than or equal to 12 hours and less than 10 days.

It is desirable that the step of forming the first layer is performed before the electrode body is formed, but performing this step after the electrode body is formed is not excluded. That is, the first layer may be formed on the surface layer part of the negative electrode mixture layer by preparing a positive electrode, preparing a negative electrode having a negative electrode mixture layer to which metal lithium is attached, forming an electrode body with a separator interposed between the positive electrode and the negative electrode, and exposing the electrode body to a carbon dioxide gas atmosphere.

The step of pre-doping the negative electrode mixture layer with lithium ions further proceeds, for example, by bringing the negative electrode mixture layer and the electrolyte into contact with each other, and is completed by being left for a predetermined time. Such a step may be a step of forming the second layer so as to cover at least a part of the first layer. For example, by charging and discharging the electrochemical device at least once, the second layer may be formed in the negative electrode mixture layer, and pre-doping of lithium ions to the negative electrode may be completed. For example, the pre-doping of the lithium ions to the negative electrode may also be completed by applying a predetermined charge voltage (for example, 3.4 V to 4.0 V) between the terminals of the positive electrode and the negative electrode for a predetermined time (for example, 1 hour to 75 hours).

The pre-doping of the negative electrode with lithium ions may be performed by bringing the negative electrode into contact with an electrolyte having lithium ion conductivity before assembling the device. As a lithium ion source used for the pre-doping, for example, metal lithium may be used. For example, a working electrode (such as a metal plate made of SUS) to which a negative electrode and the lithium ion source are attached is put into a battery container filled with an electrolyte having lithium ion conductivity in the state where a separator is interposed between the negative electrode and the working electrode, and a voltage is applied between the positive electrode and the negative electrode using the working electrode as a positive electrode, whereby pre-doping can be performed. The application of the voltage can be performed, for example, under a condition that a predetermined constant current flows between the positive electrode and the negative electrode. The voltage application time is, for example, 1 hour to 75 hours.

Metal lithium as the lithium ion source may be attached to the surface of the negative electrode mixture layer in advance, the negative electrode to which metal lithium is attached may be put into the battery container, and a voltage may be applied between the negative electrode and the working electrode to perform pre-doping.

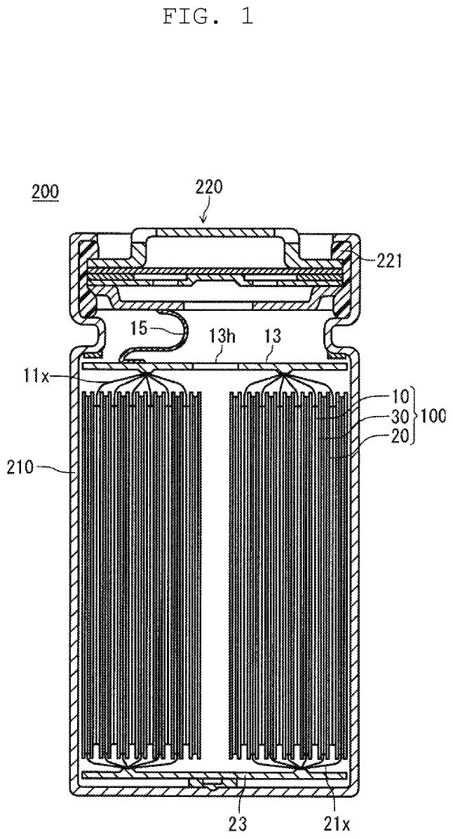

FIG. 1 schematically illustrates the configuration of electrochemical device 200 according to an exemplary embodiment of the present invention. Electrochemical device 200 includes electrode body 100, a nonaqueous electrolyte (not illustrated), bottomed cell case 210 made of metal, which accommodates electrode body 100 and the nonaqueous electrolyte, and sealing plate 220 that seals an opening of cell case 210. Gasket 221 is provided on the peripheral edge of sealing plate 220, and the open end of cell case 210 is crimped with gasket 221, whereby the inside of cell case 210 is sealed. Positive current collection plate 13 having through-hole 13h at the center is welded to positive current collector exposed part 11x. The other end of tab lead 15 having one end connected to positive current collection plate 13 is connected to an inner surface of sealing plate 220. Thus, sealing plate 220 has a function as an external positive electrode terminal. On the other hand, negative current collection plate 23 is welded to negative current collector exposed part 21x. Negative current collection plate 23 is directly welded to a welding member provided on the inner bottom surface of cell case 210. Thus, cell case 210 has a function as an external negative electrode terminal.

Hereinafter, each component of the electrochemical device according to the exemplary embodiment of the present invention will be described in more detail.

### (Negative Electrode)

The negative electrode includes a negative current collector and a negative electrode mixture layer supported on the negative current collector. The negative electrode mixture layer contains a negative electrode active material reversibly doped with lithium ions. The negative electrode active material preferably contains non-graphitizable carbon (that is, hard carbon). The thickness of the negative electrode mixture layer is, for example, 10 μm to 300 μm per surface of the negative current collector.

A sheet-shaped metallic material is used as the negative current collector. The sheet-shaped metallic material may be a metal foil, a porous metal body, an etched metal, or the like. As the metallic material, copper, a copper alloy, nickel, stainless steel, or the like may be used.

The negative current collection plate is a metal plate having a substantially disk shape. The material of the negative current collection plate is, for example, copper, a copper alloy, nickel, stainless steel, or the like. The material of the negative current collection plate may be the same as the material of the negative current collector.

The non-graphitizable carbon may have an interplanar spacing d002 (that is, the interplanar spacing between a carbon layer and a carbon layer) of the (002) plane of more than or equal to 3.8 Å as measured by an X-ray diffraction method. The theoretical capacity of the non-graphitizable carbon is desirably, for example, more than or equal to 150 mAh/g. By using non-graphitizable carbon, a negative electrode having a small low-temperature DCR and small expansion and contraction accompanying charging and discharging is likely to be obtained. The non-graphitizable carbon desirably accounts for more than or equal to 50 mass %, further, more than or equal to 80 mass %, and further, more than or equal to 95 mass % of the negative electrode active material. The non-graphitizable carbon desirably accounts for more than or equal to 40 mass %, further, more than or equal to 70 mass %, and further, more than or equal to 90 mass % of the negative electrode mixture layer.

As the negative electrode active material, non-graphitizable carbon and a material other than non-graphitizable carbon may be used in combination. Examples of the material other than non-graphitizable carbon that may be used as the negative electrode active material include graphitizable carbon (soft carbon), graphite (natural graphite, artificial graphite, and the like), lithium titanium oxide (spinel type lithium titanium oxide or the like), silicon oxide, silicon alloys, tin oxide, and tin alloys.

The average particle diameter of the negative electrode active material (in particular, non-graphitizable carbon) is preferably from 1 μm to 20 μm, inclusive, more preferably from 2 μm to 15 μm, inclusive, from the viewpoint of a high filling property of the negative electrode active material in the negative electrode and easy inhibition of side reactions with the electrolyte.

In the present specification, the average particle diameter means a volume-based median diameter (D₅₀) in a particle size distribution obtained by laser diffraction type particle size distribution measurement.

The negative electrode mixture layer contains the negative electrode active material and the conductive agent (conductive additive) as essential components and contains a binding agent, and the like as optional components. Examples of the conductive agent include carbon black and carbon fiber. Examples of the binding agent include a fluorine resin, an acrylic resin, a rubber material, and a cellulose derivative.

The negative electrode mixture layer is formed, for example, by mixing a negative electrode active material, a conductive agent, a binding agent, and the like together with a dispersion medium to prepare a negative electrode mixture slurry, applying the negative electrode mixture slurry to the negative current collector, and then drying the negative electrode mixture slurry.

The negative electrode mixture layer is pre-doped with lithium ions. This doping decreases the potential of the negative electrode and thus increases a difference in potential (that is, voltage) between the positive electrode and the negative electrode and improves energy density of the electrochemical device. The amount of lithium to be pre-doped may be, for example, about from 50% to 95% of the maximum amount that can be occluded in the negative electrode mixture layer.

The electrostatic capacity per unit mass of the negative electrode active material may be, for example, more than or equal to 1,000 F/g. From the viewpoint of increasing the capacitance density of the electrochemical device, the electrostatic capacity per unit mass of the negative electrode active material may be, for example, less than or equal to 30,000 F/g. The electrostatic capacity per unit mass of the negative electrode active material is usually larger than the electrostatic capacity per unit mass of the positive electrode active material and is, for example, 20 times to 800 times the electrostatic capacity per unit mass of the positive electrode active material. The electrostatic capacity per unit mass of the negative electrode active material may be measured by the following method.

First, a negative electrode for evaluation cut into a size of 31 mm×41 mm is prepared. As a counter electrode of the negative electrode, a metal lithium foil cut into a size of 40 mm×50 mm and having a thickness of 100 μm is prepared. A negative electrode mixture layer and the metal lithium foil are opposed to each other with a cellulose paper manufactured by NIPPON KODOSHI CORPORATION (for example, product number TF4425) having a thickness of 25 μm interposed therebetween as a separator to form an electrode body, and the electrode body is immersed in an electrolyte of Example 1 described later to assemble a cell.

The cell is charged at a constant current (CC) of 0.5 mA until the cell voltage reaches 0.01 V, then charged at a constant voltage (CV) for 1 hour, and then discharged at 0.5 mA until the cell voltage reaches 1.5 V. The electrostatic capacity per unit mass of the negative electrode active material is determined from the discharge time during a potential change of 0.1 V from the potential of the negative electrode 1 minute after the start of discharging.

### (Positive Electrode)

The positive electrode includes the positive current collector and the positive electrode mixture layer supported on the positive current collector. The positive electrode mixture layer contains the positive electrode active material reversibly doped with an anion. The positive electrode active material is, for example, a carbon material, a conductive polymer, or the like. The thickness of the positive electrode mixture layer is, for example, 10 μm to 300 μm, inclusive, per surface of the positive current collector.

A sheet-shaped metallic material is used as the positive current collector. The sheet-shaped metallic material may be a metal foil, a porous metal body, an etched metal, or the like. As the metallic material, aluminum, an aluminum alloy, nickel, titanium, or the like may be used.

The positive current collection plate is a metal plate having a substantially disk shape. It is preferable to form a through-hole serving as a passage for the nonaqueous electrolyte in the center of the positive current collection plate. The material of the positive current collection plate is, for example, aluminum, an aluminum alloy, titanium, stainless steel, or the like. The material of the positive current collection plate may be the same as the material of the positive current collector.

As the carbon material used as the positive electrode active material, a porous carbon material is preferable. For example, activated carbon or a carbon material exemplified as the negative electrode active material (for example, non-graphitizable carbon) is preferable. Examples of the raw material of activated carbon include wood, coconut shell, coal, pitch, and phenol resin. The activated carbon is preferably subjected to an activation treatment.

The average particle diameter of the activated carbon is not particularly limited and is preferably less than or equal to 20 μm, more preferably from 3 μm to 15 μm, inclusive.

The specific surface area of the positive electrode mixture layer roughly reflects the specific surface area of the positive electrode active material. The specific surface area of the positive electrode mixture layer is, for example, from 600 m²/g to 4,000 m²/g, inclusive, and is desirably from 800 m²/g to 3,000 m²/g, inclusive. The specific surface area of the positive electrode mixture layer is a BET specific surface area determined using a measurement apparatus in accordance with JIS Z 8830 (for example, TriStar II 3020 manufactured by Shimadzu Corporation). Specifically, the electrochemical device is disassembled, and the positive electrode is taken out. Next, the positive electrode is washed with DMC and dried. Thereafter, the positive electrode mixture layer is peeled off from the positive current collector, and about 0.5 g of a sample of the positive electrode mixture layer is collected. Next, the specific surface area of the collected sample is determined according to the method for measuring the specific surface area of the negative electrode mixture layer described above.

The activated carbon desirably accounts for more than or equal to 50 mass %, further, more than or equal to 80 mass %, and further, more than or equal to 95 mass % of the positive electrode active material. The activated carbon desirably accounts for more than or equal to 40 mass %, further, more than or equal to 70 mass %, and further, more than or equal to 90 mass % of the positive electrode mixture layer.

The positive electrode mixture layer contains a positive electrode active material as an essential component, and contains a conductive material, a binding agent, and the like as optional components. Examples of the conductive agent include carbon black and carbon fiber. Examples of the binding agent include a fluorine resin, an acrylic resin, a rubber material, and a cellulose derivative.

The positive electrode mixture layer is formed by, for example, mixing the positive electrode active material, the conductive agent, the binding agent, and the like with a dispersion medium to prepare a positive electrode mixture slurry, applying the positive electrode mixture slurry to the positive current collector, and thereafter drying the positive electrode mixture slurry.

The conductive polymer used as the positive electrode active material is preferably a π-conjugated polymer. As the π-conjugated polymer, for example, polypyrrole, polythiophene, polyfuran, polyaniline, poly(thiophene vinylene), polypyridine, or a derivative of these polymers may be used. These materials may be used alone or in combination of two or more kinds thereof. The weight-average molecular weight of the conductive polymer is, for example, from 1,000 to 100,000, inclusive. The derivative of the π-conjugated polymer means a polymer having, as a basic skeleton, a π-conjugated polymer such as polypyrrole, polythiophene, polyfuran, polyaniline, poly(thiophene vinylene), or polypyridine. For example, a polythiophene derivative includes poly(3,4-ethylenedioxythiophene) (PEDOT).

The conductive polymer is formed by, for example, immersing a positive current collector including a carbon layer in a reaction solution containing a raw material monomer of the conductive polymer, and electrolytically polymerizing the raw material monomer in the presence of the positive current collector. In the electrolytic polymerization, the positive current collector and a counter electrode may be immersed in a reaction solution containing a raw material monomer, and a current may be caused to flow between them with the positive current collector as an anode. The conductive polymer may be formed by a method other than electrolytic polymerization. For example, the conductive polymer may be formed by chemical polymerization of a raw material monomer. In the chemical polymerization, the raw material monomer may be polymerized with an oxidizing agent or the like in the presence of the positive current collector.

The raw material monomer used in electrolytic polymerization or chemical polymerization may be any polymerizable compound capable of producing the conductive polymer by polymerization. The raw material monomer may contain an oligomer. Examples of the raw material monomer that may be used include aniline, pyrrole, thiophene, furan, thiophene vinylene, pyridine, or a derivative of these monomers. These materials may be used alone or in combination of two or more kinds thereof. Among them, aniline is likely to grow on the surface of a carbon layer by electrolytic polymerization.

Electrolytic polymerization or chemical polymerization may be carried out using a reaction solution containing an anion (dopant). Excellent conductivity is exhibited by doping the π-electron conjugated polymer with a dopant. Examples of the dopant include a sulfate ion, a nitrate ion, a phosphate ion, a borate ion, a benzenesulfonate ion, a naphthalenesulfonate ion, a toluenesulfonate ion, a methanesulfonate ion, a perchlorate ion, a tetrafluoroborate ion, a hexafluorophosphate ion, and a fluorosulfate ion. The dopant may be a polymer ion. Examples of the polymer ion include ions of polyvinylsulfonic acid, polystyrenesulfonic acid, polyallylsulfonic acid, polyacrylsulfonic acid, polymethacrylsulfonic acid, poly(2-acrylamido-2-methylpropanesulfonic acid), polyisoprenesulfonic acid, and polyacrylic acid.

### (Separator)

As the separator, a nonwoven fabric made of cellulose fiber, a nonwoven fabric made of glass fiber, a microporous film, woven fabric, or nonwoven fabric made of polyolefin, or the like may be used. The thickness of the separator is, for example, from 8 μm to 300 μm, inclusive, preferably from 8 μm to 40 μm, inclusive.

### (Electrolyte)

The electrolyte has lithium ion conductivity and contains, for example, a lithium salt and a solvent that dissolves the lithium salt. The positive electrode is repeatedly and reversibly doped and dedoped with the lithium salt anion. Lithium ions derived from the lithium salt are reversibly occluded in and released from the negative electrode.

Examples of the lithium salt include LiClO₄, LiBF₄, LiPF₆, LiAlCl₄, LiSbF₆, LiSCN, LiCF₃SO₃, LiFSO₃, LiCF₃CO₂, LiAsF₆, LiB₁₀Cl₁₀, LiCl, LiBr, LiI, LiBCl₄, LiN(FSO₂)₂, and LiN(CF₃SO₂)₂. These materials may be used alone or in combination of two or more. Among them, a salt having a fluorine-containing anion is preferable, and in particular, lithium bis(fluorosulfonyl)imide, that is, LiN(SO₂F)₂ is preferably used. The concentration of the lithium salt in the electrolyte in a charged state (charging rate (SOC) from 90% to 100% inclusive) is, for example, from 0.2 mol/L to 5 mol/L, inclusive. Hereinafter, LiN(SO₂F)₂ is referred to as LiFSI. For example, more than or equal to 80 mass % of the lithium salt may be LiFSI.

The increase rate of the low-temperature DCR tends to be remarkably decreased by using LiFSI. It is considered that LiFSI has an effect of reducing deterioration of the positive electrode active material and the negative electrode active material. Among salts having a fluorine-containing anion, the FSI anion is considered to be excellent in stability, so that it is less likely to generate by-products but smoothly contribute to charging and discharging without damaging the surface of the active materials. In particular, when the capacity of the positive electrode is increased and the specific surface area of the negative electrode mixture layer is increased, a remarkable effect of inhibiting deterioration (effect of inhibiting an increase in low-temperature DCR) is obtained by using LiFSI with which the influence of by-products on each active material is remarkably reduced.

Examples of the solvent that may be used include: cyclic carbonates such as ethylene carbonate, propylene carbonate, and butylene carbonate; chain carbonates such as dimethyl carbonate, diethyl carbonate, and ethyl methyl carbonate; aliphatic carboxylate esters such as methyl formate, methyl acetate, methyl propionate, and ethyl propionate; lactones such as γ-butyrolactone and γ-valerolactone; chain ethers such as 1,2-dimethoxyethane (DME), 1,2-diethoxyethane (DEE), and ethoxymethoxyethane (EME); cyclic ethers such as tetrahydrofuran and 2-methyltetrahydrofuran; dimethyl sulfoxide; 1,3-dioxolane; formamide; acetamide; dimethylformamide; dioxolane; acetonitrile; propionitrile; nitromethane; ethylmonoglyme; trimethoxymethane; sulfolane; methylsulfolane; and 1,3-propane sultone. These materials may be used alone or in combination of two or more kinds thereof.

The electrolyte may contain various additive agents as necessary. For example, an unsaturated carbonate such as vinylene carbonate, vinylethylene carbonate, and divinylethylene carbonate may be added as an additive agent for forming a coating film having lithium ion conductivity on the surface of the negative electrode.

### EXAMPLES

Hereinafter, the present invention will be described in more detail by way of examples, but the present invention is not limited to examples. The outline of the configuration of each device produced below is shown in Table 1.

### (Devices A1 to A9 and B1 to B2)

### (1) Production of Positive Electrode

An aluminum foil (positive current collector) having a thickness of 20 μm was prepared. Activated carbon (average particle size: 5.5 μm) in an amount of 88 parts by mass as a positive electrode active material, 2 parts by mass of polytetrafluoroethylene (PTFE) as a binding agent, 4 parts by mass of carboxymethyl cellulose (CMC) as a thickener, and 6 parts by mass of acetylene black (AB) as a conductive additive were dispersed in water, whereby a positive electrode mixture slurry was prepared. The obtained positive electrode mixture slurry was applied to both surfaces of the aluminum foil, the coating film was dried, and the obtained material was rolled to form a positive electrode mixture layer, whereby a positive electrode was obtained. A positive current collector exposed part having a width of 10 mm was formed at an end part along a longitudinal direction of the positive current collector.

### (2) Production of Negative Electrode

A copper foil (negative current collector) having a thickness of 8 μm was prepared. Non-graphitizable carbon (HC) (average particle size: 5 μm) as a negative electrode active material, Ketjen black (KB) as a conductive additive, carboxymethyl cellulose (CMC), and styrene-butadiene rubber (SBR) were dispersed in water, whereby a negative electrode mixture slurry was obtained. The obtained negative electrode mixture slurry was applied to both surfaces of the copper foil, the coating film was dried, and the obtained material was rolled to form a negative electrode mixture layer, whereby a negative electrode was obtained.

The negative electrode mixture slurry was applied to the negative current collector such that basis weight B of the negative electrode mixture layer was 2 mg/cm² (=20 g/m²).

Thereafter, a thin film of metal lithium for pre-doping was formed on the entire surface of the negative electrode mixture layer by vacuum vapor deposition. The amount of lithium to be pre-doped was set such that the negative electrode potential in a nonaqueous electrolyte after the completion of pre-doping was less than or equal to 0.2 V with respect to metal lithium.

Thereafter, the inside of the chamber of the apparatus was purged with carbon dioxide to form a carbon dioxide gas atmosphere, whereby a first layer containing lithium carbonate on the surface layer part of the negative electrode mixture layer was formed. The dew point of the carbon dioxide gas atmosphere was −40° C., the molar fraction of carbon dioxide was 100%, and the pressure inside the chamber was 1 atm (1.01×10⁵ Pa). The temperature of the negative electrode exposed to the carbon dioxide gas atmosphere of 1 atm was set to 25° C. The time for exposing the negative electrode to the carbon dioxide gas atmosphere was set to 22 hours. The first layer was substantially free from F (or LiF).

The mixing proportion of non-graphitizable carbon (HC), Ketjen black (KB), carboxymethyl cellulose (CMC), and styrene-butadiene rubber (SBR) in the negative electrode mixture slurry was set as a mass ratio of the sum of HC and KB:CMC:SBR=94:2:4, and the mixing proportion of HC and KB was changed as shown in Table 1. The specific surface area of Ketjen black (KB) was also changed in the range of 600 m²/g to 1,400 m²/g as shown in Table 1. A plurality of negative electrodes having different compositions of the negative electrode mixture layer were thus obtained. For each negative electrode, specific surface area A of the negative electrode mixture layer was measured by the method described above.

### (3) Production of Electrode Body

An electrode body was formed by winding the positive electrode and the negative electrode in a columnar shape with a cellulose nonwoven fabric separator (with a thickness of 25 μm) interposed therebetween. At this time, the positive current collector exposed part was projected from one end surface of the wound body, and the negative current collector exposed part was projected from the other end surface of the electrode body. A disk-shaped positive current collection plate and a disk-shaped negative current collection plate were welded to the positive current collector exposed part and the negative current collector exposed part, respectively.

### (4) Preparation of Nonaqueous Electrolytic Solution

Ethylene carbonate (EC), ethyl methyl carbonate (EMC), and diethyl carbonate (DEC) were mixed at a volume ratio of 3:5:2, and 0.2 mass % of vinylene carbonate (VC) was further added, whereby a solvent was prepared. LiPF₆ as a lithium salt was dissolved in the obtained solvent at a concentration of 1.0 mol/L, whereby a nonaqueous electrolytic solution was prepared.

### (5) Assembly of Electrochemical Device

The electrode body was housed in a bottomed cell case with an opening, the tab lead connected to the positive current collection plate was connected to the inner surface of the sealing plate, and the negative current collection plate was welded to the inner bottom surface of the cell case. The nonaqueous electrolyte was put into the cell case, and then, the opening of the cell case was closed with the sealing plate. An electrochemical device as illustrated in FIG. 1 was thus assembled.

Thereafter, aging was performed at 60° C. while a charge voltage of 3.8 V was applied between terminals of the positive electrode and the negative electrode to complete pre-doping of the negative electrode with lithium ions.

A plurality of electrochemical devices A1 to A9 and B1 to B2 were thus prepared with different contents of non-graphitizable carbon (HC) and Ketjen black (KB) in the negative electrode mixture layer and/or with different specific surface areas of Ketjen black, and the following evaluations were performed.

### (6) Evaluation

### (Measurement of Internal Resistance of Electrochemical Device)

The electrochemical device immediately after aging was subjected to constant current charging at a current density of 2 mA/cm² per positive electrode area under an environment of −30° C. until the voltage reached 3.8 V, and then a state in which the voltage of 3.8 V was applied was maintained for 10 minutes. Thereafter, under an environment of −30° C., constant current discharging was performed at a current density of 2 mA/cm² per positive electrode area until the voltage reached 2.2 V.

In a discharge curve (vertical axis: discharge voltage, horizontal axis: discharge time) obtained by the above discharge, a linear approximate line of the discharge curve in the range of 0.5 seconds to 2 seconds after the start of discharge was obtained, and a voltage VS of the intercept of the linear approximate line was determined. A value (V0−VS) obtained by subtracting voltage VS from voltage V0 at the start of discharge (when 0 second has elapsed from the start of discharge) was obtained as ΔV. Internal resistance (DCR) R1 ((Ω) of the electrochemical device was determined from formula (B) shown below using ΔV(V) and a current value (current density per positive electrode area: 2 mA/cm²×positive electrode area) at the time of discharging.

$$Internal resistance R 1 = Δ V / Id \qquad ( B )$$

### (Float Test of Electrochemical Device)

Next, a float test was performed in which the electrochemical device was held for 1,000 hours in an environment of 85° C. with an application of a constant voltage of 3.8 V to the electrochemical device. Thereafter, internal resistance (DCR) R2 (Ω) of the electrochemical device was determined in the same manner as in R1 under an environment of −30° C. Using R1 and R2, deterioration rate ΔR of the internal resistance after the float test is obtained by the following Formula (C).

$$Deterioration rate Δ R = ( ( R 2 - R 1 ) / R 1 ) \times 100 \qquad ( C )$$

Table 1 shows initial internal resistance R1 and internal resistance R2 after the float test in electrochemical devices A1 to A9 and B1 to B2. In Table 1, R1 and R2 are each indicated by a relative value with initial internal resistance R1 of device A1 as 100. Electrochemical devices A1 to A9 are Examples, and B1 to B2 are Comparative Examples. In Table 1, the configurations of the negative electrode active material and the conductive additive used for forming the negative electrode mixture layer of each electrochemical device (content in the negative electrode mixture layer and specific surface area of conductive additive) are shown together with the evaluation results of the internal resistance.

Table 1 shows that, in electrochemical devices A1 to A9 in which product AB of specific surface area A and basis weight B of the negative electrode mixture layer is from 200 to 1,400, inclusive, both initial internal resistance R1 and internal resistance R2 after the float test are low, and high output can be realized. In particular, when product AB is from 340 to 1,000, inclusive, in electrochemical devices A2 to A4, A7, and A8, initial internal resistance R1 and internal resistance R2 after the float test are remarkably reduced, and excellent output characteristics are obtained.

In comparison of electrochemical devices A1 to A5, B1, and B2, as product AB of specific surface area A and basis weight B is increased, initial internal resistance R1 decreases, while the resistance change before and after the float test is large, and deterioration rate ΔR increases. As a result, internal resistance R2 after the float test is the lowest in device A3 where product AB is 600, and when product AB exceeds 600, internal resistance R2 after the float test turns to increase. In contrast, when product AB is from 200 to 1,400, inclusive, both R1 and R2 can be maintained at sufficiently low values.

In comparison of electrochemical devices A3 and A6 to A9, product AB of specific surface area A and basis weight B can be controlled by the specific surface area of the conductive additive and the content thereof. In electrochemical devices A7 to A9, by increasing the specific surface area of the conductive additive, product AB can be controlled to fall within the above-described range while the content of the conductive additive is made lower than that of A3. Thus, a higher capacitance can be realized by increasing the content of the negative electrode active material. Table 1 shows that when the specific surface area of the conductive additive is in the range of 600 m²/g to 1,400 m²/g, inclusive, initial internal resistance R1 tends to decrease as the specific surface area of the conductive additive increases. On the other hand, deterioration rate ΔR increases as the specific surface area of the conductive additive increases, and internal resistance R2 after the float test takes a minimum value as the specific surface area increases, and then turns to increase. In contrast, when the specific surface area of the conductive additive is in the range of 800 m²/g to 1,200 m²/g, inclusive, both R1 and R2 can be maintained at sufficiently low values.

TABLE 1

| | Negative electrode mixture layer | | | | | | | | |
|---|---|---|---|---|---|---|---|---|---|
| | | | Conductive additive | | Specific | | | Internal resistance | |
| | Negative electrode | | Specific | | surface | Basis | | | After |
| | active material | | surface | | area | weight | | | float |
| | | Content | area | Content | A | B | | Initial | test |
| Device | Type | (mass %) | (m²/g) | (mass %) | (m²/g) | (g/m²) | AB | R1 | R2 |
| B1 | HC | 90.5 | 800 | 3.5 | 5 | 20 | 100 | 110 | 115 |
| A1 | HC | 88 | 800 | 6 | 10 | 20 | 200 | 100 | 105 |
| A2 | HC | 86 | 800 | 8 | 17 | 20 | 340 | 90 | 96 |
| A3 | HC | 84 | 800 | 10 | 30 | 20 | 600 | 84 | 92 |
| A4 | HC | 82 | 800 | 12 | 50 | 20 | 1000 | 80 | 94 |
| A5 | HC | 80.8 | 800 | 13.2 | 70 | 20 | 1400 | 78 | 100 |
| B2 | HC | 80.2 | 800 | 13.8 | 80 | 20 | 1600 | 72 | 110 |
| A6 | HC | 80.6 | 600 | 13.4 | 30 | 20 | 600 | 95 | 107 |
| A7 | HC | 86 | 1000 | 8 | 30 | 20 | 600 | 82 | 93 |
| A8 | HC | 87.3 | 1200 | 6.7 | 30 | 20 | 600 | 79 | 94 |
| A9 | HC | 88.3 | 1400 | 5.7 | 30 | 20 | 600 | 73 | 108 |

### INDUSTRIAL APPLICABILITY

The electrochemical device according to the present invention is suitable for, for example, in-vehicle use.

### REFERENCE MARKS IN THE DRAWINGS

100 electrode body
10 positive electrode
11x positive current collector exposed part
13 positive current collection plate
15 tab lead
20 negative electrode
21x negative current collector exposed part
23 negative current collection plate
30 separator
200 electrochemical device
210 cell case
220 sealing plate
221 gasket

1. An electrochemical device comprising:
a positive electrode;
a negative electrode; and
an electrolyte having lithium ion conductivity, wherein:
the negative electrode includes a negative current collector and a negative electrode mixture layer supported on the negative current collector,
the negative electrode mixture layer contains a conductive additive and a negative electrode active material reversibly doped with a lithium ion, and
200≤AB≤1,400 is satisfied,
where
A denotes a surface area (m²/g) per unit mass of the negative electrode mixture layer,
B denotes a mass (g/m²) of the negative electrode mixture layer per a unit area of one surface of the negative current collector, and
AB denotes a product of A and B.

2. The electrochemical device according to claim 1, wherein
340≤AB≤1,000 is satisfied.

3. The electrochemical device according to claim 1, wherein:
the conductive additive includes carbon black, and
a specific surface area of the carbon black ranges from 800 m²/g to 1,200 m²/g, inclusive.

4. The electrochemical device according to claim 1, wherein the negative electrode active material includes non-graphitizable carbon.
